(19) United States
(12) Patent Application Publication
(10) Pub. No.: US 2022/0237309 A1
(43) Pub. Date: Jul. 28, 2022

(54) SIGNAL OF RISK ACCESS CONTROL

(71) Applicant: EMC IP Holding Company LLC, Hopkinton, MA (US)

(72) Inventors: Nicole Reineke, Northborough, MA (US); Hanna Yehuda, Newton, MA (US); Stephen J. Todd, Center Conway, NH (US)

(21) Appl. No.: 17/158,556

(22) Filed: Jan. 26, 2021

(51) Int. Cl. G06F 21/62

(52) U.S. Cl. CPC G06F 21/6218; G06F 2221/2111

(57) ABSTRACT

One example method includes signal of risk access control. Access control is performed based on metadata that includes at least an intent of use, a requestor, and an end user. Access to combinations of data or data sets are based on context metadata that is evaluated at the time of the request instead of after the fact. The context metadata and other labels applied to the data or data sets can be used to orchestrate data access control operations.

### FIELD OF THE INVENTION

Embodiments of the present invention generally relate to data protection. More particularly, at least some embodiments of the invention relate to systems, hardware, software, computer-readable media, and methods for data access control operations, which include risk determination and management operations.

### BACKGROUND

Computing systems today provide a large number of benefits, many of which are essential. One of the primary assets of computing systems is data. Data is crucial for practically all operations performed by computing systems. Websites, for example, often rely on large amounts of data. If that data becomes unavailable, the websites are likely to fail or not function properly until that data is restored.

Data is used for user-facing operations, internal operations, research operations, analysis operations and the like. Data can be processed, mined, analyzed, transformed, used for machine learning, or the like. In fact, many entities have large stores of data that are used for various purposes. Insurance companies, for example, may use data to determine premium pricing and risk. The data of insurance companies can also be used for compensation purposes. The ability to manipulate, use and otherwise consume data provides enormous benefits.

At the same time, however, data can be used for unapproved purposes and there is a need to manage the use of data and the ability to access data. One of the concerns with data relates to privacy or confidentiality. For example, sales data, if accessed inappropriately or even inadvertently, may expose certain private, confidential, or protected information such as the commissions or other personal data of salespersons.

One of the issues faced by various entities, as identified by chief data officers (CDOs) is that the manner in which data should be handled is often dependent on the intended use of the data. The person or user requesting a data set may not be the person consuming the data set or may not be the person using any output generated or derived from the data set. The ability to properly handle data is further complicated by the fact that the intended use of the data set or its output may change over time and the data set or its output may be merged with other data sets/outputs. In addition, the original data set may be used for multiple reasons. Consequently, controlling access is a significant concern and the ability to properly manage the data, particularly after access has been granted, is very difficult.

More generally, many businesses or other entities are concerned with controlling access to data. Many businesses have indicated that much time is spent post-processing data to ensure that the contents are suitable for a particular use case. For example, certain data may not be used to generate a premium policy quote. In another example, certain data may be intended for use by technical support, but credit card data cannot be exposed. This illustrates that the intended use of the data may impact the management of the data. Unfortunately, conventional processes to data management or access control spend substantial time and resources performing post-processing.

Data scientists also have concerns with data management. While there are technologies to provide access to data based on basic features such as user and device access permissions, these permissions are rudimentary in nature and only relate to the ability to initially access the data. Further, the data accessed by data scientists does not reflect the data that the end user has permission to access. Manually pre-processing this data is not a rational approach and even post-processing can consume time and resources.

Data management is also important because data in isolation does not have as much value to an entity. Creating data sets generates value and the value is often associated with how the data set will be used or whether it can be used. Further, the manner in which an entity treats an individual data may change in the context of a data set or when combined with other data.

Finally, a piece of data may be accessed by more than one user (e.g., two different data scientists, businesses, or other entities). Additionally, a single user may access the data with different purposes. A single rule paradigm for that piece of data is not satisfactory for data management purposes at least because that rule (e.g., permission to access) fails to account for potential uses of the data, subsequent mergers of that data into other data sets, or the like.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of conventional access control;

FIG. 2 discloses aspects of data access control system or device configured to perform signal of risk access control;

FIG. 3 discloses aspects of a method for performing data access control;

FIG. 4 discloses additional aspects of a method for performing data access control including signal of risk access control;

FIG. 5 discloses aspects of performing signal of risk access control; and

FIG. 6 discloses aspects of a computing device or system.

### DETAILED DESCRIPTION OF SOME EXAMPLE EMBODIMENTS

Embodiments of the present invention generally relate to data protection including access control. More particularly, at least some embodiments of the invention relate to systems, hardware, software, computer-readable media, and methods for signal of risk access control.

In general, example embodiments of the invention provide for controlling access to data based on a risk determination. When access to data is requested, a risk determination is performed, and access may be granted in accordance with the signaled risk.

Access to the data (and/or the risk) may be based on context metadata. The context metadata may be a superset of metadata that is generated or collected based in part on the initial access request. The context metadata may include information describing how the data will be used, which may include the formation of data sets, the identity of the requestor (e.g., user/group), or the like. Embodiment of the invention capture the intent of how, in which context, and by whom data will be used/viewed. Embodiments of the invention may provide an indication of risk of use in that context for access decisions.

Data access, which may include data management, can also be automated once access has been granted initially. The data management may consider the context in which the data is being accessed, changes in the intended use, changes in the audience, or the like.

Conventionally, data access may have passed a user or group name into a governance layer to request access permission. Embodiments of the invention, in contrast to simply determining access based on user/group, provide data governance that accounts for data as an independent entity and data as a component of a data set.

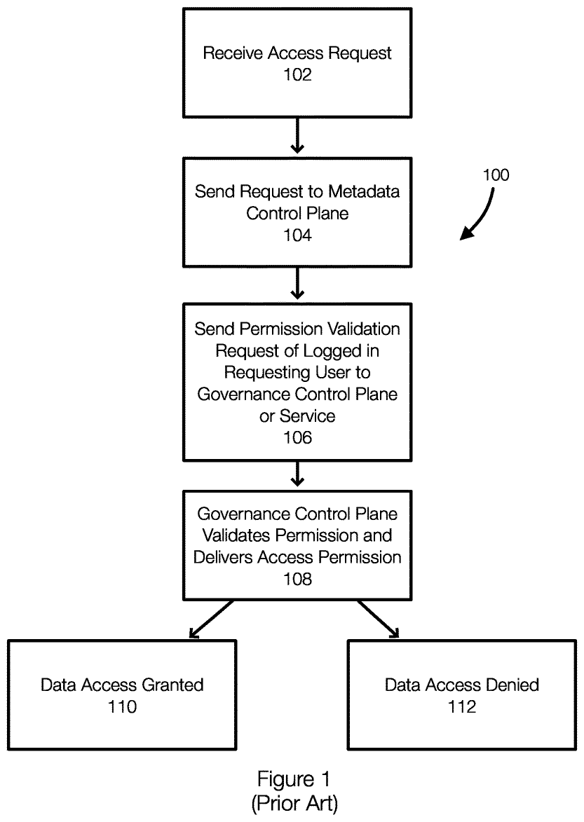

FIG. 1, for example, illustrates a conventional approach to aspects of data management. The method 100 may begin when receiving 102 a request for data access. The request may identify the data and identify the requestor. The request is sent 104 to a metadata control plane. The metadata control plane sends 106 the permission validation request of a logged in user to a governance control plane or service. Thus, the metadata control plan is a passthrough and the permission validation requested is sent to the governance control plane.

The governance control plane may validate 108 the permission of the logged in user and deliver 108 an access permission. In other words, the governance control plane may conventionally respond by granting or denying access. Thus, data access may be granted 110 or denied 112. If granted, the metadata control plane may serve or not serve the requested data based whether the permission request is validated. The method 100, in contrast to embodiments of the invention, is largely based on the user and the user's permissions.

Embodiments of the invention use a superset of information (e.g., context metadata) that may include the user/group of the requestor. However, the context metadata includes information that enables more powerful access control.

The context metadata can be used to determine a risk percentage or a signal of risk value. If the value is less than a threshold, access is granted. Otherwise, access is not granted, and a violation may be logged. In another example, access may be granted, and an indication of risk is provided to the requestor. Other outcomes are possible. In these embodiments, logs may be kept to track access requests, risk determinations/values, violations, and the like. The logs can be analyzed from the perspective of entity behavior to learn about the entity's behavior.

Embodiments of the invention may collect and/or generate metadata that is associated with an access request and that is included in the context metadata. Examples of context metadata that may passed to a governance control plane may include (by way of example only and not limitation):
users who may access the data after the data is exported,
users who may use results of data sets (e.g., outputs of data analysis, data mining),
geographical area which may access or use data or results (each country may have different regulations/access by role permission for the same piece of data),
use case of the data,
stage in which the data is being used (exploration, discovery, data model a generation, production decision making), and/or
other areas of interest.

The metadata and risk analysis performed in embodiments of the invention may also enable the automation of secondary actions. These actions can include applying rules or actions such as (by way of example only and not limitation):
access control,
discoverability,
traceability or lineage,
security,
governance,
access risk assessment
FFP established definitions of trust,
protection, and
placement.

Embodiments of the invention may be implemented as methods to generate a risk score and can also be implemented as machine learning.

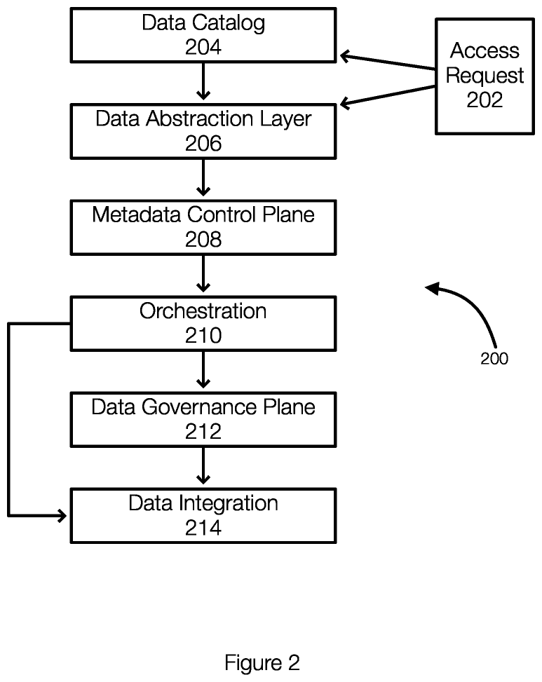

FIG. 2 discloses aspects of a system or device configured to control data access and/or use or aspects of signal of risk based access control. More specifically, FIG. 2 illustrates a computing architecture that may be implemented in a computing system and that is configured to perform risk of signal access control. Elements of FIG. 2 may be implements in servers, or other devices and may include hardware such as processors, memory, network hardware, or the like.

The architecture 200 may receive or detect an access request 202 for data. The access request 202 may be sent by a client (in response to user input), and received at a server, for example. The access request 202 may identify the data (which may be an individual data, a data set, or other data piece/group) and may identify the requestor (e.g., user/group).

When generating the access request 202, the requestor may be able to browse a data catalog 204 to select the data, may be aware of the data being requested, or may otherwise identify or request the stored in a computing system. The requested data may be stored in a local data storage, an online or cloud-based storage, a data lake, or the like.

The data abstraction layer 206 is configured to provide context to the access request 202. The data abstraction layer 206 may collect or generate metadata to be included in the context metadata. Metadata such as the intended use and the audience can be collected from the user or from the access request. Other context metadata such as data stage (exploration, discovery, data model generation, production), geographical area, other business interests, can be generated or determined. In one example, the context metadata may include, by way of example only, the intended use of the requested data set and the intended audience (the end user). The end user is the user that may use the data, results from the data, or the like in one example. The data abstraction layer 206 thus forms a superset of metadata (the context metadata) that is passed to the metadata control plane 208.

The metadata control plane 208 may add additional metadata to the requested data itself and/or to the context metadata. For example, the metadata control plane 208 may record labels on the data being requested that indicate the intended use and the intended audiences or end users associated with the access request 202. By labeling the requested data, subsequent access requests can be better evaluated in terms of control and the system can learn from this information to improve the risk of signal access control.

The orchestration 210 allows rules to access the metadata and execute. These rules may enable decision making. More specifically, orchestration 210 may handle the physical movement or placement of data between locations. The governance control plane 212 may determine whether data can be accessed or moved and the orchestration 210 orchestrates the movement or transfer of data.

The data governance plane 212 is configured to consider the intended use, the intended audiences, and/or other context metadata when making access and control decisions. The data governance plane 212 may return various values such as a risk score and an access decision. The data integration 214 may also use the rules to make decisions regarding use of the data based at least on the associated metadata. In one example, the data integration 214 may be a pipeline that allows data to be discovered and accessed.

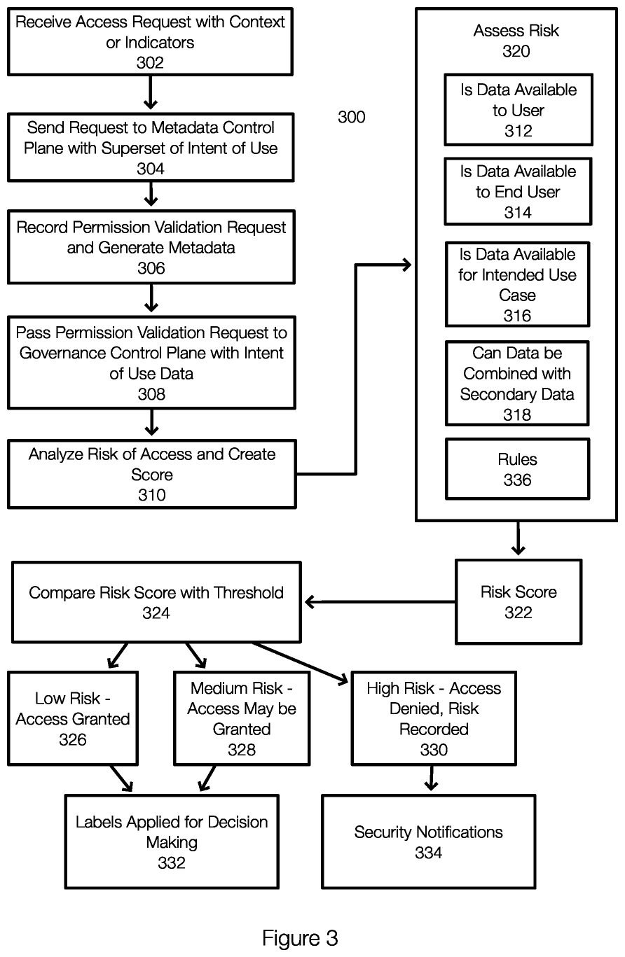

FIG. 3 discloses aspects of risk of signal access control. The method 300 is an example of a method that may be implemented by the architecture 200 illustrated FIG. 2.

The method 300 may begin when receiving 302 an access request for data. The access request may include indications or context including the intended use and the end users of the data or output generated for the intended use, in addition to information on the requestor. The context may be added to the access request by the user or context can be derived or determined from the data (e.g., labels on the data), the location of the access request, or the like.

The request is sent 304, by the data abstraction layer, to a metadata control plane with the context metadata that includes metadata related to intent to use and the audience. The context metadata, in other words, may provide insight into aspects of the access request and provides information that can be considered in evaluating the risk associated with the access request and in granting/denying the access request.

Thus, the permission validation request (the access request or portion thereof) is recorded 306 and additional metadata may be generated by the metadata control plane. More specifically, the metadata control plane may add metadata such as labels to the data that describe the intended use and the audience. This allows the data to be better understood, to manage the data during use, and for subsequent risk analyses to be better informed regarding the requested data.

The user access request (or the permission validation request) and the context metadata is provided 308 to a governance control plane. The governance control plane is configured to control access to the data and determine whether the request is granted and to determine how the request is denied/granted.

In performing this task of determining whether access is granted, the risk associated with the request and the requested data set is analyzed 310. Analyzing 310 the risk may include assessing 320 various aspects of the access request based, in part, on the context metadata. Assessing 320 various aspects of the access request may be distinct from conventional access control (e.g., role-based access control) or additive thereto. Assessing 320 risk associated with an access request presents a new way to control access that accounts not only for factors that may be related to a specific data or data set, but also for factors related to combinations of the data or data set with other data or data sets. The ability to obtain permission for data sets or combinations of data sets using signal of risk access control is substantially more than conventional access control at least because conventional access control does not account for many of the factors including combined data sets.

For example, a determination is made 312 regarding whether the requested data is available to the requesting user. For example, does the requestor have the credentials, permission and/or authority to access the requested data. If the data is not available to or cannot be accessed by the requestor, the risk score 222 may be generated at a level that denies access and other factors may not need to be evaluated. The method may then simply deny access 330 and/or make security notifications 334 as appropriate.

If the requested data is available 312 to the user, a determination is made regarding whether the data is available 314 to an end user. If the data is not available to the end user (e.g., a consumer of the data), the risk score 322 associated with granting access is increased. If the data is available to the end user, the risk score 322 may not be increased

Next, a determination may be made regarding whether the data is available for the intended use identified in the context metadata. If the data is not available for the intended use, the risk score 322 is increased. If the data is available for the intended use, the risk score may not be increased.

Next, a determination is made 318 regarding the impact of combining the requested data with other selected data as part of the intended use case. If combining the requested data with the other selected data presents a risk, the risk score 322 is increased. For example, a user may select a first data set and then select a second data set or a field from a second data set. The determination 318 may determine, using rules for example, whether these data sets can or should be combined. The risk score 322 is adjusted accordingly. For example, the second data set may contain credit card data that should not be exposed to the end user. As a result of applying this rule, a determination is made that the two data sets should not be combined, and the risk score is increased accordingly.

Further, assessing 320 the risk may also include other rules 336 applying other rules that may be entity specific (e.g., cannot display credit card numbers, social security numbers must be encrypted, data can be viewed but not exported). Often, these rules can be set by an entity. For example, accessing data in a data lake may have rules that are different from an insurance entity accessing their insurance related data. Thus, the rules 336 may account for data type, business purposes, or the like. These examples of assessing 320 risk are presented by way of example only.

Embodiments of the invention create the ability to identify, for the data access process, the users that will ultimately see the data (and/or results generated therefrom) and the use case for which the data is requested. This ability to grant/deny access based on more than simply the requestor's permissions, can help reduce time associated with post-processing. In other words, the time and resources spent post-processing the data can be avoided or minimized by performing signal of risk access control.

Thus, assessing 320 the risk may result in a risk score 322. The manner and amount in which the risk score 322 is generated can vary and may be entity specific. For example, a particular use case may carry more risk than another risk case and the risk score is impacted differently. Different users may be associated with more risk. A request from a CEO, for example, who has more authority in an organization, attempting to access an unreleased quarterly report may have a low risk score while the risk score from a new employee making an access request for the same data may be substantially higher.

Once the risk score 322 for the requested data or associated with the access request is generated, the risk score 322 may be compared 324 with acceptable thresholds. For example, if the risk score 322 is on a scale between 0 and 100, scores from 1-33 may be deemed low risk, scores from 34-66 may be deemed medium risk, and scores from 67-100 may be deemed high risk. Other scoring mechanisms or ranges or thresholds could be determined. For example, low risk may be from 1-50, medium risk may be 50-80 and high risk may be 81-100. Further, there is no limit on the number of risk categories. FIG. 3 illustrates an example of three risk categories.

If the risk score 322 is low risk, access is granted 326 to the requested data. If the risk score 322 is medium risk, access may be granted 328. A risk score of medium risk may be accompanied with a warning regarding the requested data. A risk score of high risk may be denied 330. Further, the security access risk may be recorded 334 when the risk is deemed high risk.

By creating a risk score 322, an entity or business can set thresholds of access that take into consideration the manner in which the data will be used. The decisions to grant or deny access are expanded beyond the rudimentary protection that a user simply has permission to access the data. Embodiments of the invention improve data access understanding. Plus, embodiments of the invention allow the risk to be understood in advance such that the convention post-data analysis of evaluating risk can be avoided or reduced.

Recording access requests, recording how the data will be used and accessed, and recording denials enable actions to be taken against data that has been requested.

Once data is accessed 332, labels may be added for additional decision making during use of the data and/or for subsequent access requests for the same data. If access is denied, notifications 334 may be generated. This may be used to identify the user and data that the user requested, to identify the intended use and its risk, or the like.

The data governance plane thus returns a risk score (or other signal of risk) based on business rules and combinations of data/fields/records, or data sets. The signal of risk, as previously described, may be numeric in nature. However, the risk score may be represented by color as well (green for low risk, yellow for medium risk, and red for high risk). The risk score may also be accompanied by an explanation or the explanation may be provided in the notification that may be sent to an administrator. For example, a high risk score may indicate that the combination of data or data sets poses a high risk of non-compliance. A medium risk may indicate that the combination may pose a risk of violating a rule. A low risk may indicate that no risk was detected.

The risk score acts as an automated real time check that can be used to determine risk when data sets are added or removed. For example, a user may select a first data set and a second data set. Assume that the risk is high. The user may then select only specific portions (e.g., fields) from the second data set. This may reduce the risk from high to low or medium. Advantageously, the risk is determined up front at the time or data access. This reduces rework and post-processing requirements. This also improves visibility into the various data sets and allows entities to create data sets that are in compliance with their business needs and/or other requirements (e.g., legal requirements).

Because the metadata applied to data is additive, rules can be applied to ensure compliance with any intended use requirements. For example, rules may be record rate of change for production use data, record access for production use data, apply data protection to data used by technical support, perform daily snapshots of executive dashboard data, notification of security risk on repeated deny access records, or the like.

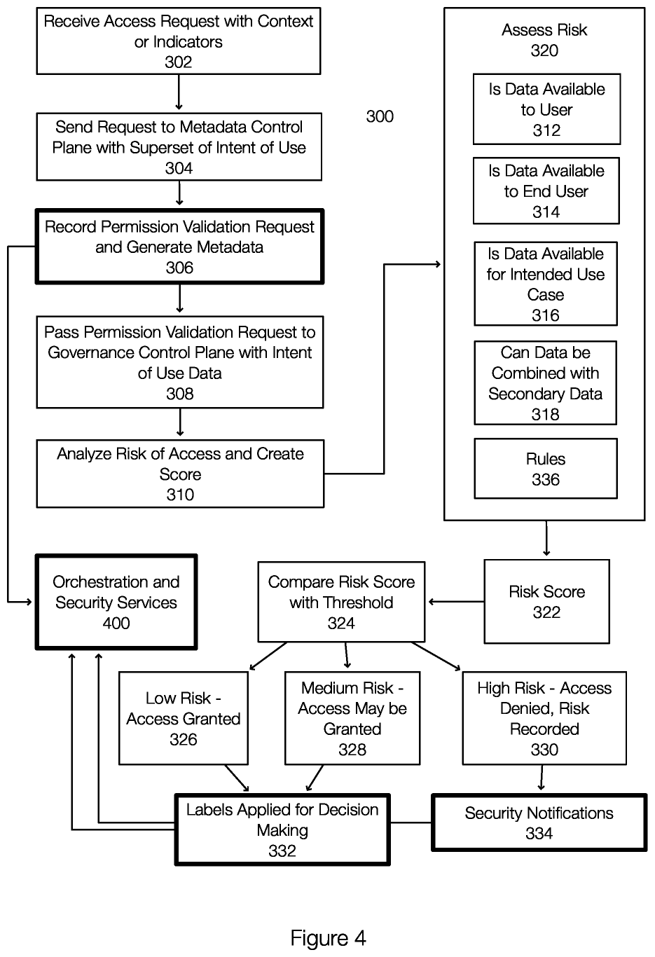

FIG. 4 discloses aspects of data management. FIG. 4 is similar to 3 and demonstrates (e.g., elements 306, 332, 334, and 400) services such as orchestration and security services can be performed 400 in a manner that accounts new metadata such as labels, denials, grants, or the like. For example, as denials are recorded, the security service may perform various actions if that data is requested again or if a particular user requests that data. The orchestration and security services 400 can perform various services while accounting for risk scores, access labels, or other notations. For example, the orchestration and security services 400 may apply rules such as traceability of the data, the discoverability of the data, the placement of the data, and the like.

As previously stated, creating a new data set that is composed of data from other data sets is conventionally a manual and arduous process. Further, it is not always apparent, when manually creating a new data set, whether any rules, regulations, laws, or organizational policies are being violated. Such a discovery may be made only after the effort to create the data set has been performed and a post-analysis on the data is conducted.

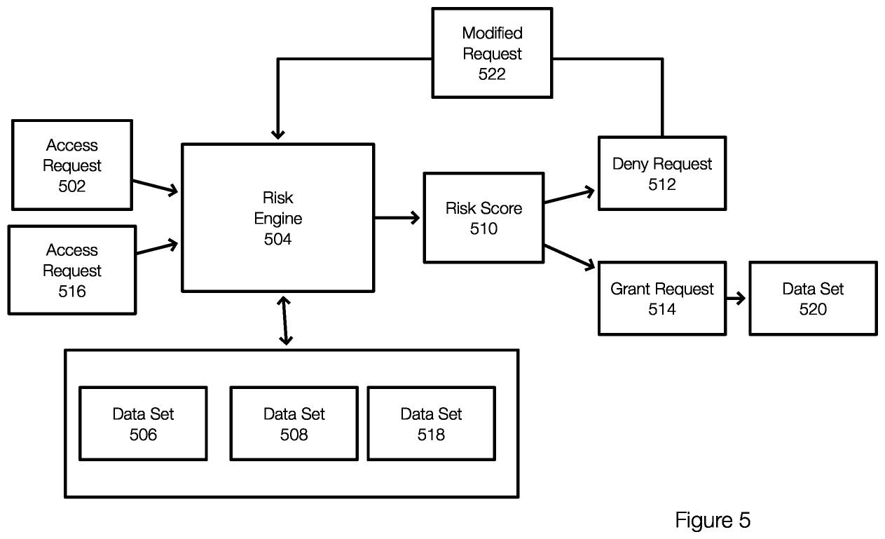

FIG. 5 illustrates an example of a risk engine operating in a computing environment. As illustrated in FIG. 5, embodiments of the invention, in real time, can understand and help users make an informed decision on whether to continue or undue an access request. For example, user may generate an access request 502 that is received by a risk engine 504 that implements an architecture 200 illustrated in FIG. 2. The risk engine 504 may be operating on one or more devices in a computing system and may have access to data, metadata, and the like.

The risk engine 504 may evaluate the metadata associated with the access request 502 and may collect/generate additional metadata. In this example, the access request 502 may include or be associated with metadata that identifies a use intent and an audience. The access request 502 may also request access to a data set 506 and a data set 508. The intent of use is to create a new data set from the data sets 506 and 508.

The risk engine 504 may generate a risk score 510 based on the context metadata passed to the governance control plane to validate whether the access request 502 is granted. Based on the risk score, the request is granted 514 or denied 512. As previously stated, the risk engine 504 may provide multiple outputs rather than simply grant/deny as previously described. In this example, the access request 502 is granted 514. The requested data sets 506 and 508 may be labeled with additional metadata based on the request regardless of whether the request is granted or denied.

In another example and in the context of the access request 502, the user makes an additional request 516 to add the data set 518 to the new data set 520 generated when the request 502 was granted. In this case, the risk engine 504 similarly evaluates the context metadata and generates a risk score. In this case, the request 516 is denied 512 and the reasons may be specified. A user may, however, be able to make a modified request 522. For example, the user may specify a specific field or portion of the data set 518 in the modified request 522 based on the denial reason. This request 522 may be granted or denied or otherwise handled.

By generating a record of intents to use and tracking use cases, data access a patterns can be followed over time. This allows more than one scoring mechanism to be generated. The risk may be determined at different stages. For example, a use case of explore data may have a high threshold for data that will not leave an exploratory environment. A use case of production may have a near-zero threshold for risk as decisions made based on the data may have litigation implications. Embodiments of the invention can thus adapt the risk score to the intent to use, the audience, and other context. Further, this is achieved in real time at the time of the request.

The following example illustrates an example or signal of risk access control. This example demonstrates that a data science user has been requested to create a model for detecting fraud in the only buying process. This may be achieved by exploring data and by modeling the data for production use by the CFO office.

The access control method may proceed as follows:
1) A data science user (Max) requests data related to an online buying process at a start of phase I. The data access request may indicate or identify the use case and the end user. Thus, the context metadata may include:
   a) the data access request indicates use case: Exploring Data
   b) The data access request indicates the end user: CFO Office
2) The data abstraction layer passes the request for the data set(s) along with the context metadata to the metadata control plane. The information passed by the data abstraction layer includes “online buying”, “exploring” and “CFO Office”. Thus, the context metadata allows the use, the audience, and other metadata to be considered when granting the access request.
3) The metadata control plane makes a record of access. This may be used to apply labels now and/or after a determination is made regarding the access request.
   a) The metadata control plane passes the access request to the data governance control plane. The data governance control play can then filter or parse the access request as follows:
      i) logged in user (has access);
      ii) requested use case (exploration: exploration has access to all data);
   b) data set access is returned with green indicator that the data can be used for this purpose;
   c) The data science user downloads the requested data and:
      i) The metadata control plane adds tags to the data in the data set including exploration and CFO Office (the intended use and the end user);
      ii) Orchestration takes these tags into account when making placement and security decisions.
   d) Data Science User Max is ready for Phase 2 of the project: the Product Model.
      i) Max requests data set “Online Buying” and requests an additional Data set “Sales Trends”;
         (1) The use case or intent to use is identified as product decision making;
         (2) The end user is the CFO Office and the CMO Office.
      ii) The data abstraction layer passes the request to the metadata control plane. and the metadata control plane passes the permissions check to the governance control plane.
         (1) The data governance control plane reviews:
            (a) the access permissions of intended end user (access granted)
            (b) FLAGS the data set combination of “online Buying” with “Sales Trends” as red because the CMO office does not have permission to view the combination of these data sets. The reason is because of the ability to tie a sales person ID to sales personnel name to sales commissions.
            (i) The metadata control plane makes a record of the denial of access.
            (ii) A secondary service reviews the denial of access for security concerns.
            1. A notification is created if the security service indicates that a notification is required.
         (2) This gives the data scientist the opportunity to proactively exclude a data field.
         (3) Once the data set meets the needs of the data scientist needs (risk score is green or low risk, the user may download the data sets.
         (4) Production-level label, CFO and CMO end user labels and data science labels are applied to the data sets (and Data).
      iii) The orchestration engine takes into consideration new labels and is able to apply:
         (1) Access Control, now that the data is production level, fewer people may be allowed to access or modify the data;
         (2) Traceability (lineage), all access requests are now recorded;
         (3) Security, movement, placement or other indicators of security may be applied;
         (4) Protection, real-time or near-real time backup rules may be applied to data with this label;
         (5) Other rules may be applied at orchestration.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, data protection operations. Such operations may include, but are not limited to, data access control operations, risk assessment operations, and other data access and management operations. More generally, the scope of the invention embraces any operating environment in which the disclosed concepts may be useful.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment. Where a backup comprises groups of data with different respective characteristics, that data may be allocated, and stored, to different respective targets in the storage environment, where the targets each correspond to a data group having one or more particular characteristics.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM)

Particularly, devices in the operating environment may take the form of software, physical machines, or VMs, or any combination of these, though no particular device implementation or configuration is required for any embodiment. Similarly, data protection system components such as databases, storage servers, storage volumes (LUNs), storage disks, replication services, backup servers, restore servers, backup clients, and restore clients, for example, may likewise take the form of software, physical machines or virtual machines (VM), though no particular component implementation is required for any embodiment. Where VMs are employed, a hypervisor or other virtual machine monitor (VMM) may be employed to create and control the VMs. The term VM embraces, but is not limited to, any virtualization, emulation, or other representation, of one or more computing system elements, such as computing system hardware. A VM may be based on one or more computer architectures, and provides the functionality of a physical computer. A VM implementation may comprise, or at least involve the use of, hardware and/or software. An image of a VM may take the form of a .VMX file and one or more .VMDK files (VM hard disks) for example. Embodiments of the invention may be containerized.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

As used herein, the term ‘backup’ is intended to be broad in scope. As such, a example backups in connection with which embodiments of the invention may be employed include, but are not limited to, full backups, partial backups, clones, snapshots, and incremental or differential backups.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted.

Following are some further example embodiments of the invention. These are presented only by way of example and are not intended to limit the scope of the invention in any way.

Embodiment 1. A method, comprising: receiving an access request for data or a data set from a user, determining context metadata data for the access request, the context metadata including an intent of use and an end user, generating a risk score based on the context metadata, wherein the risk score is generated by determining whether the user has permission to access the requested data set, determining whether the requested data set is available to the end user, and determining whether the requested data set is available for the intent of use, and granting access to the data set based on the risk score.

Embodiment 2. The method of embodiment 1, further comprising adding tags to the requested data and orchestrating actions based on the tags and other metadata associated with the requested data set, wherein the other metadata includes at least a portion of the context metadata.

Embodiment 3. The method of one or more of embodiments 1-2, further comprising orchestrating placement and security of the data set based on the tags and the other metadata.

Embodiment 4. The method of one or more of embodiments 1-3, further comprising requesting a second data access request for a second data set to be combined with the data set, wherein the second data set is associated with second context metadata including a second intent of use and a second end user.

Embodiment 5. The method of one or more of embodiments 1-4, further comprising determining whether the combination of the data set and the second set is permitted based on the context data and the second context data.

Embodiment 6. The method of one or more of embodiments 1-5, further comprising denying access to the second data set and recording a denial of access and performing a notification when indicated.

Embodiment 7. The method of one or more of embodiments 1-6, further comprising receiving a modified second access request, wherein the modified second access request modifies the second access request based on a reason provided in a denial of access.

Embodiment 8. The method of one or more of embodiments 1-7, wherein the context metadata includes one or more of: users that may access the data set, users that may use results of the data set, a geographical area that may access the data set or the results, a stage in which the data is being used, and/or areas of interest to an owner of the data set.

Embodiment 9. The method of one or more of embodiments 1-8, further comprising actions on the data set based on the risk score and the context metadata, the actions including one or more of access control, discoverability, traceability, security, governance, protection, placement, definitions of trust.

Embodiment 10. The method of one or more of embodiments 1-9, further comprising learning behavior based on access patterns, wherein the access patterns are generated at least from records of access, each record of access including one or more of an intent to use, an end user, tags, access grants, and/or access denials.

Embodiment 11. A method for performing any of the operations, methods, or processes, or any portion of any of these, of embodiments 1-10 or otherwise disclosed herein.

Embodiment 12. A non-transitory storage medium having stored therein instructions that are executable by one or more hardware processors to perform operations comprising the operations of any one or more of embodiments 1 through 11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, agent, engine, layer, plane, or the like may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

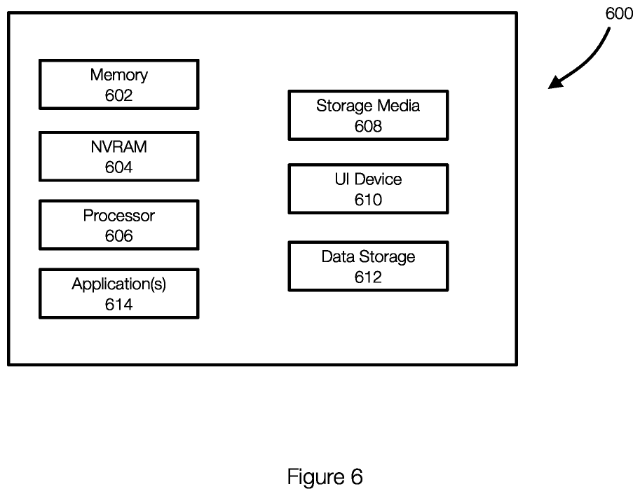

With reference briefly now to FIG. 6, any one or more of the entities disclosed, or implied, by the Figures and/or elsewhere herein, may take the form of, or include, or be implemented on, or hosted by, a physical computing device, one example of which is denoted at 600. As well, where any of the aforementioned elements comprise or consist of a virtual machine (VM), that VM may constitute a virtualization of any combination of the physical components disclosed in FIG. 6.

In the example of FIG. 6, the physical computing device 600 includes a memory 602 which may include one, some, or all, of random access memory (RAM), non-volatile memory (NVM) 604 such as NVRAM for example, read-only memory (ROM), and persistent memory, one or more hardware processors 606, non-transitory storage media 608, UI device 610, and data storage 612. One or more of the memory or storage components of the physical computing device 600 may take the form of solid state device (SSD) storage. As well, one or more applications 614 may be provided that comprise instructions executable by one or more hardware processors 606 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving an access request for data or a data set from a user;
determining context metadata data for the access request, the context metadata including an intent of use and an end user;
generating a risk score based on the context metadata, wherein the risk score is generated by determining whether the user has permission to access the requested data or data set, determining whether the requested data or data set is available to the end user, and determining whether the requested data or data set is available for the intent of use; and
granting access to the data or data set based on the risk score.

2. The method of claim 1, further comprising adding tags to the requested data and orchestrating actions based on the tags and other metadata associated with the requested data or data set, wherein the other metadata includes at least a portion of the context metadata.

3. The method of claim 2, further comprising orchestrating placement and security of the data or data set based on the tags and the other metadata.

4. The method of claim 1, further comprising requesting a second data access request for a second data or data set to be combined with the data or data set, wherein the second data or data set is associated with second context metadata including a second intent of use and a second end user.

5. The method of claim 4, further comprising determining whether the combination of the data or data set and the second set is permitted based on the context data and the second context data.

6. The method of claim 4, further comprising:
denying access to the second data or data set and/or denying access to a combination of the data or data set and the second data or data set; and
recording a denial of access and performing a notification when indicated.

7. The method of claim 4, further comprising receiving a modified second access request, wherein the modified second access request modifies the second access request based on a reason provided in a denial of access.

8. The method of claim 1, wherein the context metadata includes one or more of:
users that may access the data or data set;
users that may use results of the data or data set;
a geographical area that may access the data or data set or the results;
a stage in which the data is being used; and/or
areas of interest to an owner of the data or data set.

9. The method of claim 1, further comprising actions on the data or data set based on the risk score and the context metadata, the actions including one or more of access control, discoverability, traceability, security, governance, protection, placement, definitions of trust.

10. The method of claim 1, further comprising learning behavior based on access patterns, wherein the access patterns are generated at least from records of access, each record of access including one or more of an intent to use, an end user, tags, access grants, and/or access denials.

11. A non-transitory storage medium having stored therein instructions that are executable by one or more hardware processors to perform operations comprising:
receiving an access request for data or a data set from a user;
determining context metadata data for the access request, the context metadata including an intent of use and an end user;
generating a risk score based on the context metadata, wherein the risk score is generated by determining whether the user has permission to access the requested data or data set, determining whether the requested data or data set is available to the end user, and determining whether the requested data or data set is available for the intent of use; and
granting access to the data or data set based on the risk score.

12. The non-transitory storage medium of claim 11, further comprising adding tags to the requested data and orchestrating actions based on the tags and other metadata associated with the requested data or data set, wherein the other metadata includes at least a portion of the context metadata.

13. The non-transitory storage medium of claim 12, further comprising orchestrating placement and security of the data or data set based on the tags and the other metadata.

14. The non-transitory storage medium of claim 11, further comprising requesting a second data access request for a second data or data set to be combined with the data or data set, wherein the second data or data set is associated with second context metadata including a second intent of use and a second end user.

15. The non-transitory storage medium of claim 14, further comprising determining whether the combination of the data or data set and the second set is permitted based on the context data and the second context data.

16. The non-transitory storage medium of claim 14, further comprising:
denying access to the second data or data set and/or denying access to a combination of the data or data set and the second data or data set; and
recording a denial of access and performing a notification when indicated.

17. The non-transitory storage medium of claim 14, further comprising receiving a modified second access request, wherein the modified second access request modifies the second access request based on a reason provided in a denial of access.

18. The non-transitory storage medium of claim 11, wherein the context metadata includes one or more of:
users that may access the data or data set;
users that may use results of the data or data set;
a geographical area that may access the data or data set or the results;
a stage in which the data is being used; and/or
areas of interest to an owner of the data or data set.

19. The non-transitory storage medium of claim 11, further comprising actions on the data or data set based on the risk score and the context metadata, the actions including one or more of access control, discoverability, traceability, security, governance, protection, placement, definitions of trust.

20. The non-transitory storage medium of claim 11, further comprising learning behavior based on access patterns, wherein the access patterns are generated at least from records of access, each record of access including one or more of an intent to use, an end user, tags, access grants, and/or access denials.
